(19) United States
(12) Patent Application Publication
(10) Pub. No.: US 2013/0212815 A1
(43) Pub. Date: Aug. 22, 2013

(54) GAUGE WHEEL ASSEMBLY FOR HAND HELD PORTABLE POWER TOOL

(71) Applicants: Russell J. Kempf, Kewaskum, WI (US); Perry S. Kempf, Verona, WI (US)

(72) Inventors: Russell J. Kempf, Kewaskum, WI (US); Perry S. Kempf, Verona, WI (US)

(21) Appl. No.: 13/402,735

(22) Filed: Feb. 22, 2012

(51) Int. Cl. A46B 13/02; B25F 5/00; G01B 5/20

(52) U.S. Cl. 15/22.1; 33/203; 173/184

(57) ABSTRACT

A gauge wheel assembly for a hand held portable power tool has first and second gauge wheels arranged on opposite lateral sides of a working attachment of the tool to contact the ground and gauge the height of the working attachment relative to the ground. The gauge wheel assembly includes a clamp assembly that clamps to an outer surface of a tubular boom of the tool. First and second arms extend outwardly from opposite lateral sides of the clamp assembly and have distal portions that support the gauge wheels adjacent to the lateral sides of the working attachment. A plurality of mounting locations are provided in the distal portions of the first and second arms for adjustably mounting the gauge wheels to the arms. The working attachment can be a rotary sweeper that extends in a cantilever fashion from a center gearbox attached to the tubular boom.

### BACKGROUND OF THE INVENTION

1. Field of the Invention

This invention relates generally to hand held portable power tools of the type having an elongate tubular boom with a motor at one end and a working attachment at the other end, and in particular, to a gauge wheel assembly for use with such tools.

2. Description of the Related Art

Hand held portable power tools are commonly used for landscape trimming, sidewalk edging, power sweeping, snow clearing, and a variety of other tasks. Such tools typically include an elongate tubular boom with a motor at one end, a working attachment at the other end, and a handle for holding and operating the tool. A power drive mechanism extends through the tubular boom to connect the motor to the working attachment.

Rotary sweeper attachments for such power tools are used to provide power sweeping for removing stones, snow, or other undesirable material from lawns, sidewalks, driveways, and similar areas. A brush-type rotary sweeper attachment is disclosed in U.S. Pat. No. 6,041,463. Paddle-type rotary sweeper attachments are disclosed in U.S. Pat. Nos. 5,161,318 and 5,269,082. These rotary sweeper attachments have a gear box attached to the tubular boom, and output shafts extending from opposite lateral sides of the gear box. Rotary sweeper assemblies are attached to and extend from the output shafts in a cantilever fashion without any supports at their outer free ends.

The sweeper assemblies are rotatably driven about respective horizontal axes by the output shafts, which receive power through the gear box and drive mechanism from the motor. As the sweeper assemblies rotate, they are passed over the undesirable material and cause the material to be moved to a desirable location.

Existing hand held power tools with sweeper attachments are difficult to operate and put a large amount of strain on the operator during use. The weight of the tool is either carried completely by the rotary sweeper assemblies, or partly by the operator and partly by the rotary sweeper assemblies. As a result, the tool can be difficult and inefficient to maneuver because the engine has to work against the weight of the tool.

There is a need in the industry for a device that makes rotary sweeper attachments more user friendly to reduce operator fatigue.

### SUMMARY OF THE INVENTION

An object of the present invention is to provide a device for supporting a rotary sweeper attachment of a hand held power tool relative to the surface being swept to make the tool more user friendly and reduce operator fatigue.

A further object of the present invention is to provide a gauge wheel assembly for use with a hand held power tool to provide a constant guide and gauging means for a working tool attachment, such as a rotary sweeper attachment, relative to the surface being contacted by the working tool attachment.

A further object of the present invention is to provide a gauge wheel assembly that can be connected to an elongate tubular boom of a hand held power tool for use with a rotary sweeper attachment.

A further object of the present invention is to provide a gauge wheel assembly that can be easily attached to an elongate tubular boom of a hand held power tool, that has a plurality of adjusted positions to provide different operating heights for a working attachment, that takes weight of the working attachment off of the operator to reduce fatigue and muscle strain, that reduces the need for an operator harness to help carry the weight of the power tool, and that makes the hand held power tool more maneuverable.

To accomplish these and other objects, the present invention provides a gauge wheel assembly for a hand held portable power tool. The gauge wheel assembly has first and second gauge wheels arranged on opposite lateral sides of a working attachment of the tool to contact the ground and gauge the height of the working attachment relative to the ground. The gauge wheel assembly includes a clamp assembly that clamps to an outer surface of a tubular boom of the tool. First and second arms extend outwardly from opposite lateral sides of the clamp assembly and have distal portions that support the gauge wheels in close proximity and adjacent to the lateral sides of the working attachment. A plurality of mounting locations are provided in the distal portions of the first and second arms for adjustably mounting the gauge wheels to the arms. The working attachment can be, for example, a rotary sweeper that extends in a cantilever fashion from a center gearbox attached to the tubular boom.

According to one aspect of the present invention, a gauge wheel assembly is provided for use with a hand held portable power unit, comprising: a clamp assembly having first and second clamping blocks adapted to be positioned on opposite sides of an elongate tubular boom and a means for squeezing the clamping blocks into clamping engagement with an outer surface of the tubular boom; first and second arms extending from the clamp assembly, the first and second arms having respective distal portions located on opposite lateral sides of a working tool attachment attached to the tubular boom; and first and second gauge wheels connected to the distal portions of the first and second arms, respectively. The first and second gauge wheels are arranged to contact the ground and provide gauging of the working tool attachment relative to the ground.

According to another aspect of the present invention, a hand held portable power tool is provided, comprising: an elongate tubular boom having a first end and a second end opposite from the first end; a motor disposed at the first end of the boom for providing power to the tool; a working attachment disposed at the second end of the boom; a power drive mechanism extending through the tubular boom from the motor to the working attachment; and a gauge wheel assembly attached to the tubular boom. The gauge wheel assembly comprises first and second gauge wheels arranged on opposite lateral sides of the working attachment, respectively, to contact the ground and provide gauging of the working attachment relative to the ground.

Numerous other objects of the present invention will be apparent to those skilled in this art from the following description wherein there is shown and described an example embodiment of the present invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the present invention is made with reference to the accompanying drawings. In the drawings:

FIG. 1 is a perspective side view of a hand held portable power tool with a gauge wheel assembly according to the present invention.

FIG. 2 is a perspective front view of the hand held portable power tool with the gauge wheel assembly of the present invention.

FIG. 3 is a plan view of the hand held portable power tool with the gauge wheel assembly of the present invention.

FIG. 4 is a side elevation view of the hand held portable power tool with the gauge wheel assembly of the present invention.

FIG. 5 is a perspective bottom view of the hand held portable power tool with the gauge wheel assembly of the present invention.

FIG. 6 is a perspective top view of the hand held portable power tool with the gauge wheel assembly of the present invention.

FIG. 7 is an exploded perspective view of the lower end of the hand held portable power tool and the gauge wheel assembly of the present invention.

### DETAILED DESCRIPTION OF THE INVENTION

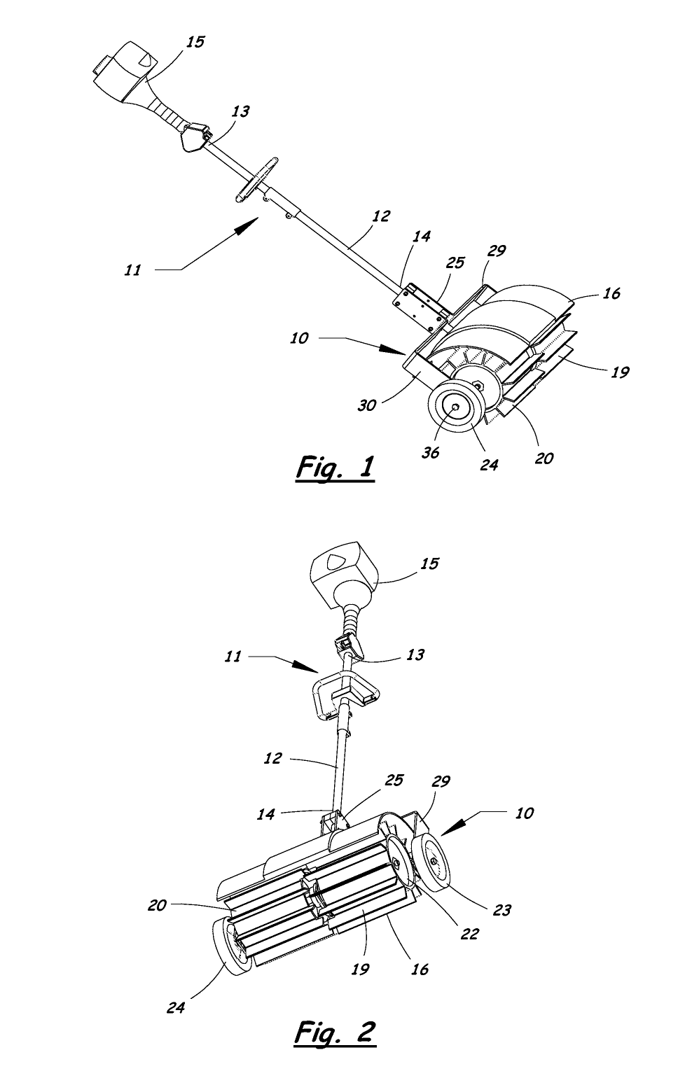

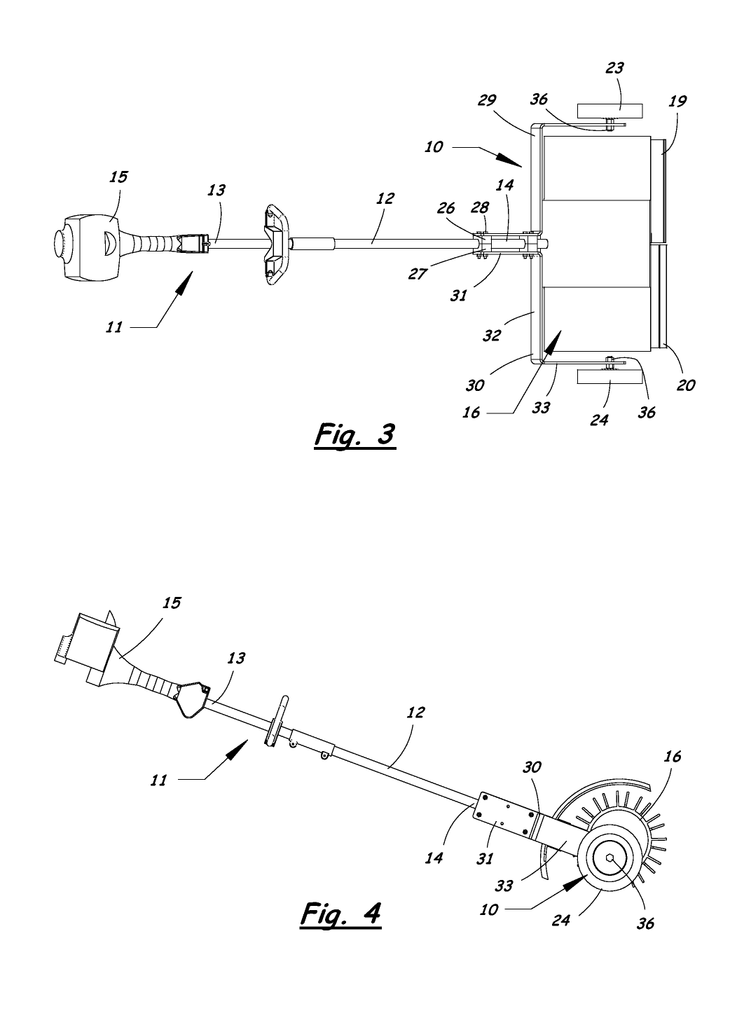

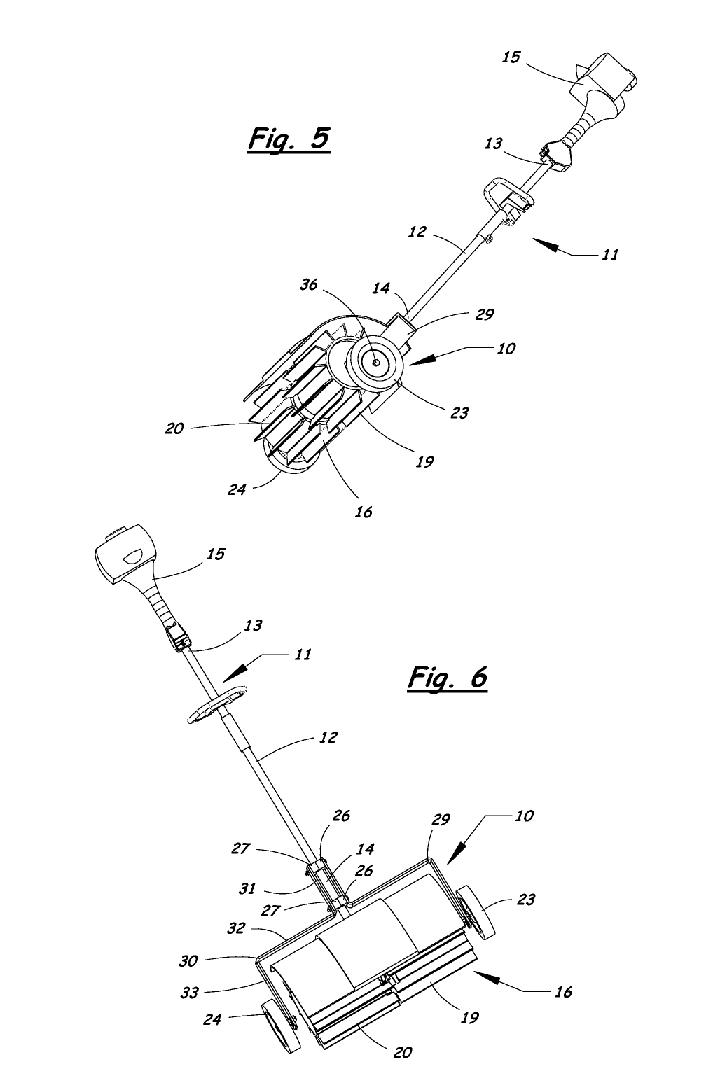

A gauge wheel assembly 10 for use with a hand held portable power tool 11 according to the present invention will now be described in detail with reference to FIGS. 1 to 7 of the accompanying drawings.

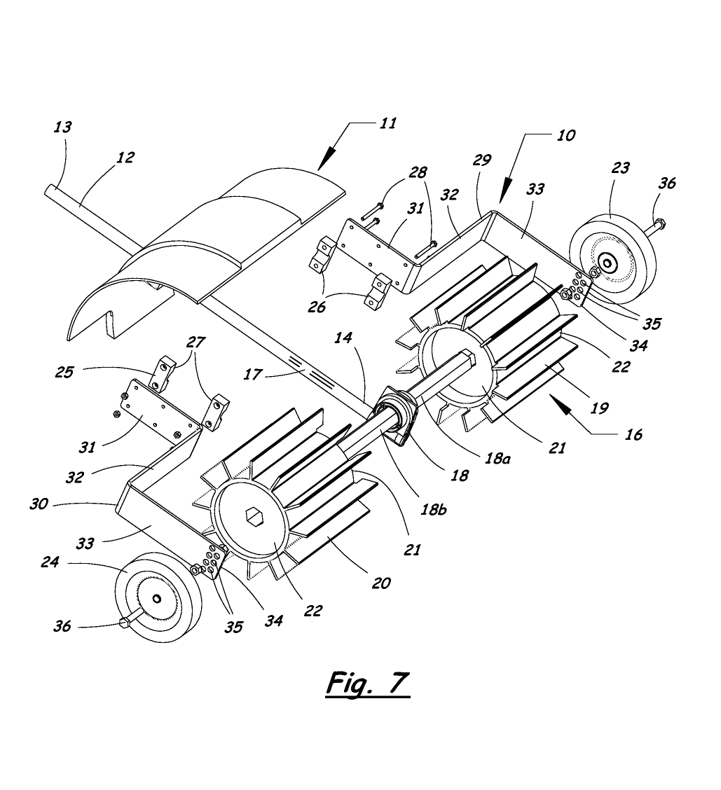

A hand held portable power tool 11 with a gauge wheel assembly 10 of the present invention is illustrated in various views in FIGS. 1 to 6, and in further detail in the exploded view of FIG. 7. The hand held power tool 11 includes an elongate tubular boom 12 having first and second ends 13, 14 opposite from each other. A motor 15 is disposed at the first end 13 of the tubular boom 12 for providing power to the tool 11. The motor 15 can be a gas engine or other type of power supply suitable for a hand held tool.

A working attachment 16 is disposed at the second end 14 of the tubular boom 12. A power drive mechanism 17 extends through the tubular boom 12 from the motor 15 to the working attachment 16 to provide drive power to the working attachment 16. The power drive mechanism 17 can be a drive shaft as commonly used on hand held power tools, such as string trimmers and the like.

The working attachment 16 includes a gear box 18 attached to the second end 14 of the boom 12 for receiving drive power from the power drive mechanism 17. The gear box 18 has first and second output shafts 18a, 18b that extend generally horizontally from opposite lateral sides of the gear box 18. First and second rotary sweeper assemblies 19, 20 are attached to the first and second output shafts 18a, 18b, respectively. Each of the sweeper assemblies 19, 20 has an inner end 21 attached to a respective one of the output shafts 18a, 18b, and an outer free end 22. The sweeper assemblies 19, 20 extend from the output shafts 18a, 18b in a cantilever fashion without any supports at their outer free ends 22. The output shafts 18a, 18b and the sweeper assemblies 19, 20 are arranged to rotate about a common axis that extends substantially perpendicular to the tubular boom 12.

For example, the power tool 11 and working attachment 16 can be constructed as illustrated and described in U.S. Pat. Nos. 5,161,318, 5,269,082 or 6,041,463. In U.S. Pat. Nos. 5,161,318 and 5,269,082, a paddle-type rotary sweeper attachment is disclosed, and in U.S. Pat. No. 6,041,463, a brush-type rotary sweeper attachment is disclosed. The contents of these prior patents are incorporated herein by reference.

The gauge wheel assembly 10 is attached to the tubular boom 12 near the second end 14. The gauge wheel assembly 10 includes first and second gauge wheels 23, 24 arranged on opposite lateral sides of the working attachment 16, respectively, to contact the ground and provide gauging of the working attachment 16 relative to the ground. The gauge wheels 23, 24 are located adjacent to the outer free ends 22 of the sweeper assemblies 19, 20. The gauge wheels 23, 24 are arranged to rotate about axes that are substantially parallel with the axes of rotation of the rotary sweeper assemblies 19, 20.

The gauge wheel assembly 10 includes a clamp assembly 25 having first and second clamping blocks 26, 27 positioned on opposite sides of the tubular boom 12. A plurality of threaded fasteners 28 extend through aligned holes in the first and second clamping blocks 26, 27 to provide a means for squeezing the clamping blocks 26, 27 into clamping engagement with an outer surface of the tubular boom 12. Other clamping arrangements, such as a clamping collar with a single threaded clamping bolt, can also be used to provide a means for squeezing the clamping blocks into clamping engagement with the tubular boom 12. The clamp assembly 25 allows the gauge wheel assembly 10 to be attached to a tubular boom 12 of a conventional power tool 11 without drilling holes, welding, or otherwise modifying the existing tubular boom 12 or the working attachment 16.

The gauge wheel assembly 10 includes first and second support arms 29, 30 that extend from the clamp assembly 25 to the opposite lateral sides of the working attachment 16. The first and second arms 29, 30 each have a first portion 31 extending generally parallel to the tubular boom 12 on a respective side of the clamp assembly 25. The threaded fasteners 28 for squeezing the clamping blocks 26, 27 into clamping engagement with the tubular boom 12 also extend through aligned holes in the first portions 31 of the support arms 29, 30 for connecting the support arms 29, 30 to the clamping blocks 26, 27.

The first and second arms 29, 30 each have a second portion 32 extending laterally outwardly from a forward end of the first portion 31, and a third portion 33 extending forward from an outer end of the second portion 32. The second portions 32 are generally perpendicular to the first portions 31, and the third portions 33 are generally perpendicular to the second portions 32 and parallel to the tubular boom 12. The first and second arms 29, 30 are each formed of a planar member having substantially perpendicular bends between the first and second portions 31, 32 and between the second and third portions 32, 33, respectively.

The third portions 33 are located on the opposite lateral sides of the working attachment 16. The third portions 33 have distal portions 34 located adjacent to their forward ends. A plurality of mounting holes 35 are provided in the distal portions 34 of the third portions 33 of the arms 29, 30 for mounting the gauge wheels 23, 24 to the arms 29, 30. The mounting holes 35 provide a plurality of mounting locations for adjustably mounting the gauge wheels 23, 24 to the arms 29, 30 in close proximity to the outer free ends of the working attachment 16. A threaded fastener 36 extends through a selected one of the mounting holes 35 to mount each gauge wheel 23, 24. The threaded fasteners 36 provide axes of rotation for the gauge wheels 23, 24.

The mounting holes 35 are located in close proximity to the outer ends 22 of the paddles or brushes 19, 20, and directly below the axis of rotation of the paddles or brushes 19, 20. As a result, the axes of rotation of the gauge wheels 23, 24 are located in close proximity and slightly below the axes of rotation of the paddles or brushes 19, 20. This arrangement allows the paddles or brushes 19, 20 to remain in a substantially constant relationship with the surface being swept or brushed, even as the engine 15 and first end 13 of the handle 12 are raised and lowered during use. This arrangement also increases the life of the attachment 16 because the load is kept substantially constant at all times.

The mounting holes 35 are arranged so that the lowest holes on each side will provide a mounting location for the gauge wheels 23, 24 to support the working attachment 16 with a clearance between the attachment and the surface being swept. The holes located above the lowest holes will provide mounting locations to support the working attachment 16 with more interference between the paddles or brushes 19, 20 and the surface being swept. The lower the position of the gauge wheels 23, 24 relative to the working attachment 16, the less aggressive the paddles or brushes 19, 20 will be. By using mounting holes 35 at the same height on each side, the gauge wheels 23, 24 will support the working attachment 16 in a horizontal orientation to provide uniform clearance/interference across the width of the tool 11 during use.

The gauge wheel assembly 10 provides several advantages over the prior art. The gauge wheel assembly 10 can be provided in a kit form, which can be retrofitted to an existing tool 11 by clamping the clamp assembly 25 to the outside surface of the tubular boom 12 of the tool 11. Since the clamp assembly 25 attaches to the outside surface of the tubular boom 12, it is not necessary to modify the tubular boom 12 or other parts of the hand tool 11 or working attachment 16 to accommodate the gauge wheel assembly 10. The gauge wheel assembly 10 can be attached to any tool 11 having a tube diameter that is compatible with the dimensions of the clamp assembly 25.

The gauge wheel assembly 10 eliminates or reduces the need for a harness to support part of the weight of the hand tool 11. Instead, the weight of the tool 11 is carried by the wheels 23, 24, which take the weight of the attachment off of the operator and thus reduce fatigue and muscle strain. The gauge wheel assembly 10 also makes the hand tool 11 more maneuverable, and allows the tool 11 to be moved to different areas without carrying it. The gauge wheel assembly 10 allows a faster and more efficient sweeping process, therefore using less fuel. The engine and transmission mechanism no longer have to work against the entire weight of the working attachment 16 and tool 11. The gauge wheel assembly 10 also makes it possible to operate the tool 11 with one hand.

The gauge wheel assembly 10 of the present invention can also be integrated into a hand held power tool or the working attachment as original equipment, instead of as an after market kit. In this case, the gauge wheel assembly 10 can be attached to or integrated into the tool 11 by means other than a clamp assembly that clamps onto the tubular boom 12. For example, the tubular boom 12 or the working attachment 16 can be formed with a suitable flange for attaching the arms 29, 30 of the gauge wheel assembly 10 to the tool 11.

While the invention has been specifically described in connection with specific embodiments thereof, it is to be understood that this is by way of illustration and not of limitation, and the scope of the appended claims should be construed as broadly as the prior art will permit.

What is claimed is:

1. A gauge wheel assembly for use with a hand held portable power unit, comprising:
a clamp assembly having first and second clamping blocks adapted to be positioned on opposite sides of an elongate tubular boom and a means for squeezing the clamping blocks into clamping engagement with an outer surface of the tubular boom;
first and second arms extending from said clamp assembly, said first and second arms having respective distal portions located on opposite lateral sides of a working tool attachment attached to the tubular boom; and
first and second gauge wheels connected to said distal portions of said first and second arms, respectively, said first and second gauge wheels being arranged to contact the ground and provide gauging of the working tool attachment relative to the ground.

2. The gauge wheel assembly according to claim 1, wherein said first and second gauge wheels are adjustably mounted on said distal portions of said first and second arms, respectively.

3. The gauge wheel assembly according to claim 1, wherein each of said first and second arms comprises a first portion connected to said clamp assembly, a second portion extending outwardly from the clamp assembly, and a third portion extending generally perpendicular to the second portion.

4. The gauge wheel assembly according to claim 3, wherein each of said first and second arms comprises a planar member having substantially perpendicular bends between said first and second portions and between said second and third portions, respectively.

5. The gauge wheel assembly according to claim 3, wherein said third portions of said first and second arms comprise a plurality of mounting holes for mounting the gauge wheels to the arms, said mounting holes providing a plurality of mounting locations for adjustably mounting the gauge wheels to the arms.

6. The gauge wheel assembly according to claim 1, wherein said means for squeezing the clamping blocks into clamping engagement comprises a plurality of threaded fasteners that extend through aligned holes in said first and second clamping blocks.

7. The gauge wheel assembly according to claim 1, wherein each of said first and second arms comprises a first portion extending generally parallel to the tubular boom on a respective side of the clamp assembly, a second portion extending outwardly from a forward end of the first portion and generally perpendicular to the first portion, and a third portion which extends forward from an outer end of the second portion and generally parallel to the tubular boom, said distal portions of said first and second arms being located adjacent to forward ends of said third portions of the arms.

8. A hand held portable power tool, comprising:
an elongate tubular boom having a first end and a second end opposite from said first end;
a motor disposed at the first end of the boom for providing power to the tool;
a working attachment disposed at the second end of the boom;
a power drive mechanism extending through the tubular boom from the motor to the working attachment; and
a gauge wheel assembly attached to the tubular boom, said gauge wheel assembly comprising first and second gauge wheels arranged on opposite lateral sides of the working attachment, respectively, to contact the ground and provide gauging of the working attachment relative to the ground.

9. The hand held portable power tool according to claim 8, wherein said gauge wheel assembly comprises a clamp assembly having first and second clamping blocks positioned on opposite sides of said tubular boom, and a means for squeezing the clamping blocks into clamping engagement with an outer surface of the tubular boom.

10. The hand held portable power tool according to claim 9, wherein said means for squeezing the clamping blocks into clamping engagement comprises a plurality of threaded fasteners that extend through aligned holes in said first and second clamping blocks.

11. The hand held portable power tool according to claim 8, wherein said gauge wheel assembly comprises a clamp assembly for clamping against an outer surface of the tubular boom, and first and second arms extending from said clamp assembly to said opposite lateral sides of the working attachment.

12. The hand held portable power tool according to claim 11, wherein each of said first and second arms comprises a first portion connected to said clamp assembly, a second portion extending outwardly from the clamp assembly, and a third portion extending generally perpendicular to the second portion, said third portions being located on said opposite lateral sides of the working attachment.

13. The hand held portable power tool according to claim 12, wherein each of said first and second arms comprises a planar member having substantially perpendicular bends between said first and second portions and between said second and third portions, respectively.

14. The hand held portable power tool according to claim 12, wherein said third portions of said first and second arms comprise a plurality of mounting holes for mounting the gauge wheels to the arms, said mounting holes providing a plurality of mounting locations for adjustably mounting the gauge wheels to the arms.

15. The hand held portable power tool according to claim 10, wherein each of said first and second arms comprises a first portion extending generally parallel to the tubular boom on a respective side of the clamp assembly, a second portion extending outwardly from a forward end of the first portion and generally perpendicular to the first portion, and a third portion extending forward from an outer end of the second portion and generally parallel to the tubular boom, said third portions being located on said opposite lateral sides of the working attachment and providing mounting locations for said gauge wheels.

16. The hand held portable power tool according to claim 8, wherein said first and second gauge wheels are adjustably mounted on said first and second arms, respectively.

17. The hand held portable power tool according to claim 8, wherein said working attachment comprises a rotary sweeper.

18. The hand held portable power tool according to claim 8, wherein said working attachment comprises a gear box attached to the second end of the boom for receiving drive power from said power drive mechanism, said gear box comprising first and second output shafts extending generally horizontally from opposite sides of said gear box, and first and second rotary sweeper assemblies each having an inner end attached to a respective one of said first and second shafts and an outer free end, and said gauge wheels are rotatably mounted to said first and second arms at locations adjacent to said outer free ends.

19. The hand held portable power tool according to claim 18, wherein said first and second output shafts and said first and second sweeper assemblies are arranged to rotate about a common axis that extends substantially perpendicular to said tubular boom.

20. The hand held portable power tool according to claim 18, wherein said first and second sweeper assemblies are attached to and extend from said first and second shafts in a cantilever fashion without any supports at said outer free ends thereof, and wherein said first and second arms support said gauge wheels adjacent to said outer free ends of the sweeper assemblies, said gauge wheels and said rotary sweeper assemblies having axes of rotation that are substantially parallel with each other.
